(19) United States
(12) Patent Application Publication
(10) Pub. No.: US 2009/0147405 A1
(43) Pub. Date: Jun. 11, 2009

(54) METHOD FOR MANUFACTURING MAGNETIC RECORDING MEDIUM, MAGNETIC RECORDING MEDIUM MANUFACTURED BY THE SAME, AND MAGNETIC RECORDING APPARATUS INCORPORATING THE MAGNETIC RECORDING MEDIUM

(75) Inventors: Hirotaka Oshima, Higashine (JP); Hideyuki Kikuchi, Higashine (JP); Takeshi Morikawa, Kawasaki (JP); Hiroshi Nakao, Higashine (JP); Ken-ichi Itoh, Yamato (JP); Hideki Masuda, Tokyo (JP); Kazuyuki Nishio, Tokyo (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); KANAGAWA ACADEMY OF SCIENCE AND TECHNOLOGY, Kawasaki-shi (JP)

(21) Appl. No.: 12/326,634

(22) Filed: Dec. 2, 2008

(30) Foreign Application Priority Data
Dec. 5, 2007 (JP) 2007-314941

(51) Int. Cl. G11B 5/48; B29C 39/00; G11B 5/62

(52) U.S. Cl. 360/244; 264/259; 264/299; 264/294; 264/337; 428/800; G9B/5.147

(57) ABSTRACT

A method for manufacturing a magnetic recording medium which has a substrate and a magnetic layer formed on the substrate, the method including: forming the magnetic layer over a convexo-concave pattern provided on a surface of a mold, and releasing the mold from the magnetic layer formed on the substrate.

### CROSS-REFERENCE TO RELATED APPLICATIONS

This application is based upon and claims the benefits of the priority from the prior Japanese Patent Application No. 2007-314941 filed on Dec. 5, 2007, the entire contents of which are incorporated herein by reference.

### BACKGROUND OF THE INVENTION

1. Field of the Invention

The present invention relates to a magnetic recording medium which is suitable, for example, in hard disk devices widely used as external storage devices for computers, consumer video recording devices, etc. and which is large in capacity and capable of high-density recording; a method for efficiently manufacturing the same at low cost; and a magnetic recording apparatus incorporating the magnetic recording medium.

2. Description of the Related Art

In recent years, along with technological innovations in the IT industry and the like, research and development for making magnetic recording media large in capacity, high in speed and low in cost has been actively carried out.

As next-generation ultrahigh-density perpendicular magnetic recording media, so-called patterned media are attracting attention, in which by separately placing magnetic materials responsible for individual signals (magnetic bits), a favorable balance between heat fluctuation resistance and a high SN ratio is achieved, and bit density is thereby increased.

As to the patterned media, it is necessary to form a pattern of submicron order on the entire surface of a magnetic disk with high precision and at low cost. For instance, in the case of a patterned medium in which nanoholes in anodized alumina are filled with magnetic metal, it is known that if a concave pattern where the nanoholes are to be formed is formed on a surface of an aluminum layer before carrying out anodic oxidation, ordered arrangement of the nanoholes is enabled (refer to Japanese Patent Application Laid-Open (JP-A) No. 10-121292).

The present inventors have realized one-dimensional alignment of nanoholes in the circumferential direction of a magnetic disk by forming a groove pattern, not a concave pattern (refer to JP-A No. 2005-305634).

Also, in order to achieve a favorable balance between heat fluctuation resistance and a high SN ratio and thereby to increase bit density, it is necessary for magnetic materials to be of the order of nanometers in size; thus, development of a method for producing nanosized magnetic materials having desired sizes and magnetic properties is the key to achieving a favorable balance between heat fluctuation resistance and a high SN ratio and increasing bit density.

Examples of the method for producing nanosized magnetic materials include a direct imaging method in which a pattern is formed for each magnetic disk by EB lithography or other lithography; and an imprinting method in which a mold (otherwise referred to as “stamper”) is produced based upon an imaged pattern, and the pattern formed on the mold is transferred. Note that the latter method is superior in productivity.

Examples of the method for producing nanosized magnetic materials by an imprinting method include a method in which a magnetic layer formed over a substrate with the use of a resist mask (or a metal mask produced using the resist mask) formed by an imprinting method is subjected to microfabrication by dry etching; and a method in which a substrate (e.g. a Si substrate) is processed so as to have a concavo-convex pattern by an imprinting method first, then a magnetic layer is formed over the processed substrate, and the magnetic layer having the concavo-convex pattern is thus formed.

It is generally important for the above-mentioned patterned media to record magnetic signals onto magnetic dots, which are responsible for individual magnetic bits, as correctly as possible, and to detect the magnetic signals from the magnetic dots as correctly as possible. In order to synchronize the magnetic dot positions and the recording positions correctly and avoid mistakenly detecting signals from the magnetic dots, it is necessary to reduce variations in the effective size, positions and magnetic properties of the magnetic dots inside the media surface as much as possible. Also, the size of unnecessary magnetic material portions, which can only generate magnetic fields that are sources of noise and which are not responsible for magnetic information, needs to be reduced as much as possible.

Generally, however, microfabrication of a magnetic layer by means of dry etching is liable to cause variations in size, shape, etc., and as the processed form of the magnetic layer becomes minute, its magnetic properties and a patterned shape to be formed can hardly be made sufficiently uniform, which is problematic. Meanwhile, there is great uniformity in the case where a magnetic layer is formed after a pattern has been formed on a substrate; however, the magnetic layer is also formed on a trench (concave) portion, and there is such a problem that noise is caused by this magnetic layer formed on the trench (concave) portion, thereby degrading the recording and reproducing properties.

The present invention solves the problems in the art and is aimed at achieving the following object. An object of the present invention is to provide a method for manufacturing a magnetic recording medium, which is capable of transferring a convexo-concave pattern on a surface of a mold with high precision and of producing a high-definition nanosized magnetic material pattern suitable for patterned media, and which is superior in productivity and low in cost; a magnetic recording medium which is suitable, for example, in hard disk devices widely used as external storage devices for computers, consumer video recording devices, etc. and which is large in capacity and capable of high-density recording; and a magnetic recording apparatus incorporating the magnetic recording medium.

### BRIEF SUMMARY OF THE INVENTION

Means for solving the problems are as follows. A method of the present invention for manufacturing a magnetic recording medium is a method for manufacturing a magnetic recording medium which has a substrate and a magnetic layer formed on the substrate, the method including: forming the magnetic layer over a convexo-concave pattern provided on a surface of a mold, and releasing the mold from the magnetic layer formed on the substrate.

Also, the method may further include unmagnetizing the magnetic layer, which involves forming a non-magnetic layer by removing magnetism of a part of the magnetic layer from a surface of the magnetic layer opposite to another surface thereof in contact with the mold. The method may further include forming a base layer over the non-magnetic layer. And the method may further include bonding the substrate to a surface of the base layer opposite to another surface thereof in contact with the non-magnetic layer, with the use of an adhesive.

The unmagnetizing step may further include flattening the surface of the magnetic layer opposite to the other surface thereof in contact with the mold, by etching, polishing, etc. for the purpose of effecting uniform unmagnetization. Additionally, for the mold, a resin provided with a desired convexo-concave pattern may be used. Further, in that case, the mold may be released in the mold releasing step by dissolving the resin.

As to the method for manufacturing a magnetic recording medium, in the magnetic layer forming step, the magnetic layer is formed over the convexo-concave pattern provided on the surface of the mold. In the unmagnetizing step, the non-magnetic layer is formed by removing magnetism of a part of the magnetic layer from the surface of the magnetic layer opposite to the other surface thereof in contact with the mold. In the base layer forming step, the base layer is formed over the non-magnetic layer. In the substrate bonding step, the substrate is bonded to the surface of the base layer opposite to the other surface thereof in contact with the non-magnetic layer, with the use of an adhesive. In the mold releasing step, the mold is released from the magnetic layer. Thus, the convexo-concave pattern on the mold is transferred in an inverted manner with high precision, and a high-definition concavo-convex pattern is formed on the surface of the magnetic layer. Consequently, a magnetic recording medium which is large in capacity and capable of high-density recording can be efficiently manufactured at low cost.

A magnetic recording medium of the present invention is a magnetic recording medium manufactured by a manufacturing method including the steps consisting of forming a magnetic layer over a convexo-concave pattern provided on a surface of a mold; unmagnetizing the magnetic layer, which involves forming a non-magnetic layer by removing magnetism of a part of the magnetic layer from a surface of the magnetic layer opposite to another surface thereof in contact with the mold; forming a base layer over the non-magnetic layer; bonding a substrate to a surface of the base layer opposite to another surface thereof in contact with the non-magnetic layer, with the use of an adhesive; and releasing the mold from the magnetic layer.

In the magnetic recording medium, the magnetic layer on which a concavo-convex pattern is formed is provided on the substrate, with the adhesive layer being placed in between, and the concavo-convex pattern (magnetic pattern) on the magnetic layer is formed by transfer of the convexo-concave pattern on the mold in an inverted manner with high precision and has desired magnetic properties; thus, the magnetic recording medium is large in capacity, capable of high-density recording and very high in quality. Accordingly, the magnetic recording medium is suitable, for example, in hard disk devices widely used as external storage devices for computers, consumer video recording devices, etc.

A magnetic recording apparatus of the present invention is a magnetic recording apparatus including a magnetic recording medium, a magnetic recording medium rotating mechanism, a magnetic head, an arm member, and a moving mechanism, wherein the magnetic recording medium is manufactured by a manufacturing method including the steps consisting of forming a magnetic layer over a convexo-concave pattern provided on a surface of a mold, unmagnetizing the magnetic layer, which involves forming a non-magnetic layer by removing magnetism of a part of the magnetic layer from a surface of the magnetic layer opposite to another surface thereof in contact with the mold, forming a base layer over the non-magnetic layer, bonding a substrate to a surface of the base layer opposite to another surface thereof in contact with the non-magnetic layer, with the use of an adhesive, and releasing the mold from the magnetic layer; the magnetic recording medium rotating mechanism rotates the magnetic recording medium; the arm member incorporates the magnetic head; and the moving mechanism moves the magnetic head by moving the arm member.

According to the present invention, it is possible to solve problems in the art and provide a method for manufacturing a magnetic recording medium, which is capable of transferring a convexo-concave pattern on a surface of a mold with high precision and producing a high-definition nanosized magnetic material pattern suitable for patterned media, and which is superior in productivity and low in cost; a magnetic recording medium which is suitable, for example, in hard disk devices widely used as external storage devices for computers, consumer video recording devices, etc. and which is large in capacity and capable of high-density recording; and a magnetic recording apparatus incorporating the magnetic recording medium.

### BRIEF DESCRIPTION OF THE SEVERAL VIEWS OF THE DRAWINGS

FIG. 1A is a diagram for explaining a method of the present invention for manufacturing a magnetic recording medium (Part 1).

FIG. 1B is a diagram for explaining the method of the present invention for manufacturing a magnetic recording medium (Part 2).

FIG. 1C is a diagram for explaining the method of the present invention for manufacturing a magnetic recording medium (Part 3).

FIG. 1D is a diagram for explaining the method of the present invention for manufacturing a magnetic recording medium (Part 4).

FIG. 1E is a diagram for explaining the method of the present invention for manufacturing a magnetic recording medium (Part 5).

FIG. 1F is a diagram for explaining the method of the present invention for manufacturing a magnetic recording medium (Part 6).

FIG. 2A is a diagram for explaining a modified example of a method of the present invention for manufacturing a magnetic recording medium (Part 1).

FIG. 2B is a diagram for explaining the modified example of the method of the present invention for manufacturing a magnetic recording medium (Part 2).

FIG. 2C is a diagram for explaining the modified example of the method of the present invention for manufacturing a magnetic recording medium (Part 3).

FIG. 2D is a diagram for explaining the modified example of the method of the present invention for manufacturing a magnetic recording medium (Part 4).

FIG. 2E is a diagram for explaining the modified example of the method of the present invention for manufacturing a magnetic recording medium (Part 5).

FIG. 2F is a diagram for explaining the modified example of the method of the present invention for manufacturing a magnetic recording medium (Part 6).

FIG. 3A is a schematic explanatory diagram showing an example of a push-up mechanism used in a mold releasing step in a method of the present invention for manufacturing a magnetic recording medium.

FIG. 3B is a schematic explanatory diagram showing an example of a mold releasing step that uses the push-up mechanism shown in FIG. 3A.

FIG. 4A is a schematic process diagram showing an example of a method for producing a bonded structure composed of a substrate and a magnetic layer, in an example of a method of the present invention for manufacturing a magnetic recording medium (Part 1).

FIG. 4B is a schematic process diagram showing the example of the method for producing a bonded structure composed of a substrate and a magnetic layer, in the example of the method of the present invention for manufacturing a magnetic recording medium (Part 2).

FIG. 4C is a schematic process diagram showing the example of the method for producing a bonded structure composed of a substrate and a magnetic layer, in the example of the method of the present invention for manufacturing a magnetic recording medium (Part 3).

FIG. 4D is a schematic process diagram showing the example of the method for producing a bonded structure composed of a substrate and a magnetic layer, in the example of the method of the present invention for manufacturing a magnetic recording medium (Part 4).

FIG. 5A is a schematic process diagram for explaining a case where a plurality of substrates are together subjected to a magnetic layer forming step, a substrate bonding step, an unmagnetizing step and a mold releasing step (Part 1).

FIG. 5B is a schematic process diagram for explaining the case where a plurality of substrates are together subjected to a magnetic layer forming step, a substrate bonding step, an unmagnetizing step and a mold releasing step (Part 2).

FIG. 5C is a schematic process diagram for explaining the case where a plurality of substrates are together subjected to a magnetic layer forming step, a substrate bonding step, an unmagnetizing step and a mold releasing step (Part 3).

FIG. 5D is a schematic process diagram for explaining the case where a plurality of substrates are together subjected to a magnetic layer forming step, a substrate bonding step, an unmagnetizing step and a mold releasing step (Part 4).

FIG. 5E is a schematic explanatory diagram showing a plurality of bonded structures composed of substrates and magnetic layers, obtained in the case where a plurality of substrates are together subjected to a magnetic layer forming step, a substrate bonding step, an unmagnetizing step and a mold releasing step.

FIG. 6 is an AFM image of a 150 nm-pitch land/groove structure of a CoPt magnetic material manufactured by a method of the present invention for manufacturing a magnetic recording medium.

FIG. 7 is an AFM image of a 100 nm-pitch triangle lattice dot structure of a CoPt magnetic material manufactured by a method of the present invention for manufacturing a magnetic recording medium.

FIG. 8A is a schematic explanatory diagram showing a magnetic recording apparatus of the present invention.

FIG. 8B is a schematic explanatory diagram showing a hard disk drive to which a magnetic recording apparatus of the present invention has been applied.

### DETAILED DESCRIPTION OF THE INVENTION

### (Method for Manufacturing Magnetic Recording Medium)

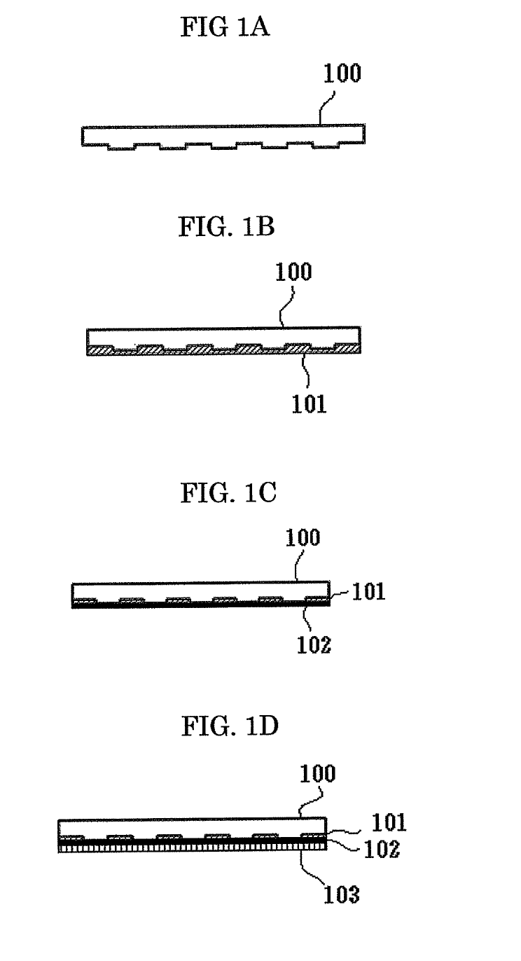

As shown in FIGS. 1A to 1F, a method of the present invention for manufacturing a magnetic recording medium includes at least a magnetic layer forming step and a mold releasing step, preferably includes an unmagnetizing step, a base layer forming step, a substrate bonding step, a flattening step, etc., and further includes additional steps, such as a protective layer forming step, suitably selected according to necessity.

### <Magnetic Layer Forming Step>

The magnetic layer forming step is a step of forming a magnetic layer over a convexo-concave pattern provided on a surface of a mold. For instance, as shown in FIG. 1B, the magnetic layer forming step is a step of forming a magnetic film (magnetic layer) 101 over a convexo-concave pattern provided on a mold 100.

### —Mold—

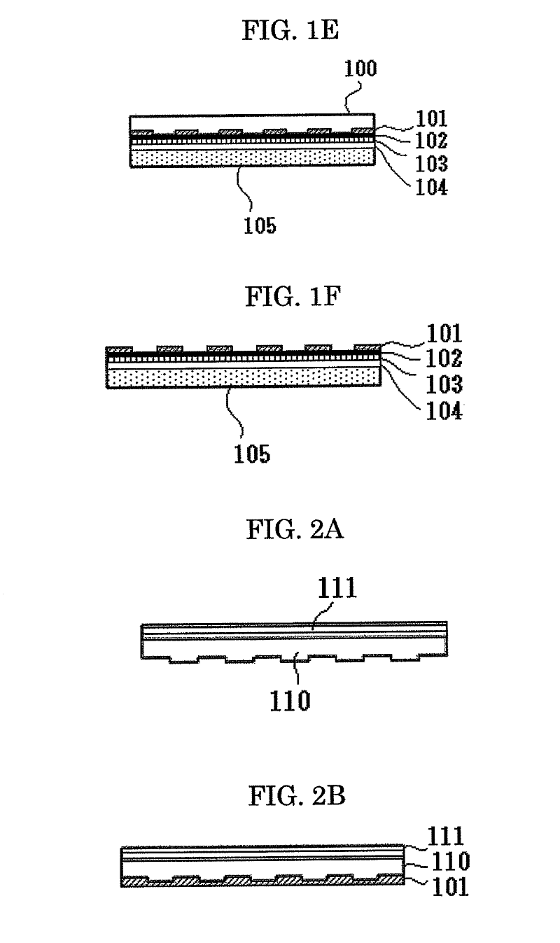

The mold is not particularly limited as long as it has a convexo-concave pattern on its surface, and the material thereof can be suitably selected according to the purpose. For instance, silicon, silicon oxide films, combinations of these, and the like are preferable because they are most widely used as materials for producing minute structures in the field of semiconductors; silicon carbide and the like are preferable in that they are superior in durability against continuous use; and Ni used in molding optical discs, and the like are preferable. Also, thermoplastic resins and photocurable resins, both of which are provided with concavo-convex portions by an imprinting method, may be used (e.g. a structure serving as a mold, composed of a substrate 111 for resin, and a resin 110 formed on the substrate 111 for resin, as shown in FIGS. 2A to 2F). The mold can be used a plurality of times. It should be noted that when a thermoplastic resin or photocurable resin, provided with concavo-convex portions by an imprinting method, is used, the resin can easily be released from a magnetic layer without needing to apply a releasing agent in a mold releasing step described later.

The convexo-concave pattern on the mold is preferably a convexo-concave pattern corresponding to a concavo-convex pattern on a magnetic layer to be formed, namely a convexo-concave pattern including land portions (convex portions) and groove portions (concave portions) formed by inverting those included in a desired concavo-convex pattern on the magnetic layer.

The shape of the groove portions (concave portions) is not particularly limited and can be suitably selected according to the purpose; however, the shape is preferably the shape of dots, which are responsible for magnetic bits, or the shape of lines, which are responsible for servo signals. The cross-sectional shape of the concave portions is not particularly limited and can be suitably selected according to the purpose, and examples thereof include square shapes, V shapes and semicircular shapes.

Also, it is desirable that the groove portions (concave portions) be concentrically or spirally aligned. Specifically, when used for a hard disk, it is desirable that they be concentrically aligned in terms of facilitation of access, whereas when used for a videodisk, it is desirable that they be spirally aligned in terms of facilitation of continuous reproduction. In the case where the groove portions (concave portions) are concentrically or spirally aligned, convex portions on a magnetic material to be formed can be concentrically or spirally aligned as well.

The depth of the groove portions (concave portions) in the convexo-concave pattern is not particularly limited and can be suitably selected according to the purpose. For instance, the depth is preferably 5 nm or greater, more preferably 10 nm to 100 nm.

### —Magnetic Layer—

The material for the magnetic layer is not particularly limited and can be suitably selected according to the purpose, with examples thereof including metals, metal oxides, metal nitrides and alloys. However, it is desirable that the material have perpendicular magnetic anisotropy in terms of achievement of high density, and examples of such a material include CoPt alloys, Co/Pt multilayer films, Co/Pd multilayer films, FePt alloys and TbFeCo alloys. Additionally, in order to control the crystal anisotropy of the magnetic layer for the purpose of obtaining desired magnetic properties, a buffer layer made of Ru, Pt, etc. may be formed before forming the magnetic layer.

The magnetic layer can be formed in accordance with a known method, and suitable examples thereof include sputtering and vapor deposition. The magnetic layer forming conditions are not particularly limited and can be suitably selected according to the purpose.

It is desirable that the magnetic layer forming step include applying a releasing agent over the convexo-concave pattern on the mold before forming the magnetic layer. In this case, the mold can easily be released from the magnetic layer in the mold releasing step described later. The releasing agent is not particularly limited and can be suitably selected according to the purpose, and examples thereof include surface treating agents. Suitable examples thereof include fluorine-based surface treating agents and silane coupling agents. Suitable examples of the fluorine-based surface treating agents include NOVEC EGC-1720 produced by Sumitomo 3M Limited, and suitable examples of the silane coupling agents include OPTOOL DSX produced by Daikin Industries, Ltd.

By means of the above-mentioned step, the magnetic layer is formed over the convexo-concave pattern provided on the mold.

### <Unmagnetizing Step>

The unmagnetizing step is a step of forming a non-magnetic layer by removing magnetism of a part (trench portion) of the magnetic layer from the surface of the magnetic layer opposite to the other surface thereof in contact with the mold. For instance, as shown in FIG. 1C, the unmagnetizing step is a step of forming a non-magnetic intermediate film (non-magnetic layer) 102 by removing magnetism of a part (trench portion) of the magnetic film (magnetic layer) 101. The method of the unmagnetization is not particularly limited and can be suitably selected according to the purpose. For instance, it is advisable to remove magnetism by plasma oxidation, ion implantation, etc.

Also, before the unmagnetizing step, there may be provided a flattening step for flattening the surface of the magnetic layer opposite to the other surface thereof in contact with the mold, by ion beam etching, chemical mechanical polishing (CMP), etc. for the purpose of effecting uniform unmagnetization. Further, the unmagnetizing step may denote physical removal of the magnetic layer by the etching, the polishing, etc.

By means of the unmagnetizing step, magnetism of the part (trench portion) of the magnetic layer is removed from the surface of the magnetic layer opposite to the other surface thereof in contact with the mold.

<Base Layer Forming Step>

The base layer forming step is a step of forming over the non-magnetic layer a base layer that includes a surface to be bonded to a substrate with an adhesive after the non-magnetic layer has been formed in the unmagnetizing step. For instance, as shown in FIG. 1D, the base layer forming step is a step of forming a soft magnetic under layer (SUL) 103 as a base layer over the non-magnetic intermediate film (non-magnetic layer) 102. The base layer may include a soft magnetic layer functioning as a soft magnetic under layer. Also, a close contact layer for maintaining adhesive strength may be included as an outermost surface. Additionally, the base layer can be formed in accordance with a known method, and examples thereof include vacuum deposition methods such as sputtering and vapor deposition, electrodeposition and electroless plating.

By means of the base layer forming step, the base layer having a desired thickness is formed over the non-magnetic layer.

### <Substrate Bonding Step>

The substrate bonding step is a step of bonding the substrate to the outermost surface of the base layer on the opposite side to the mold (the surface of the base layer opposite to the other surface thereof in contact with the non-magnetic layer), using an adhesive. For instance, as shown in FIG. 1E, the substrate bonding step is a step of bonding a substrate 105 to the surface of the soft magnetic under layer (SUL) 103, using an adhesive 104.

### —Substrate—

The shape, structure, size, material and the like of the substrate are not particularly limited and can be suitably selected according to the purpose. The shape is preferably a disc-like shape, when the magnetic recording medium is a magnetic disk such as a hard disk. The structure may be a single-layer structure or a laminated structure. Examples of the material include glass, aluminum, silicon and quartz.

Specific examples of the substrate include glass substrates, aluminum substrates and silicon substrates, which serve as magnetic disk substrates. For the substrate, a suitably produced substrate or a commercially available substrate may be used.

### —Adhesive—

The adhesive is not particularly limited and can be suitably selected according to the purpose. Specifically, for the adhesive, an epoxy resin adhesive is preferable in that its adhesive strength is great, a low cure shrinkage adhesive is preferable in that its cure shrinkage rate is small, a modified silicone resin adhesive is preferable in that it is superior in bonding materials that have different coefficients of thermal expansion, and a cyanoacrylate adhesive is preferable in that it can cure in a short period of time. These adhesives may be used independently or in combination.

For the epoxy resin adhesive, a two-component adhesive is generally used, and suitable examples thereof include BOND WHITE FOR REPAIRING ENAMEL PRODUCTS and BOND E SET produced by Konishi Co., Ltd., EP007 produced by Cemedine Co., Ltd., and EPICLON EXA-4850 SERIES produced by Dainippon Ink And Chemicals, Incorporated.

For the low cure shrinkage adhesive, EPICLON EXA-4850-150 produced by Dainippon Ink And Chemicals, Incorporated, which utilizes TETA (triethylenetetramine) as a curing agent, for example, is suitable in that it has both flexibility and toughness and has a small cure shrinkage rate of 0.6%.

Suitable examples of the modified silicone resin adhesive include BOND MOS 7 produced by Konishi Co., Ltd., and PM SERIES produced by Cemedine Co., Ltd.

Suitable examples of the cyanoacrylate adhesive include BOND ARON ALPHA WITH SHOCK RESISTANCE FOR PROFESSIONAL USE produced by Konishi Co., Ltd.

By means of the above-mentioned step, the substrate is bonded to the surface of the base layer on the opposite side to the mold, using the adhesive. Consequently, the magnetic layer, the base layer and the substrate are laid in this order over the convexo-concave pattern on the mold.

### <Mold Releasing Step>

The mold releasing step is a step of releasing the mold from the magnetic layer after the substrate bonding step. For instance, as shown in FIG. 1F, the mold releasing step is a step of releasing the mold 100 from the magnetic film (magnetic layer) 101.

The method of releasing the mold from the magnetic layer is not particularly limited and can be suitably selected according to the purpose, and examples thereof include a method of releasing the mold from the magnetic layer by providing a cut at the interface between the mold and the magnetic layer, using an edge of a knife. In this method, however, creases may appear on the surface of the magnetic layer owing to nonuniform stress caused when the mold is released.

Accordingly, it is desirable that the mold releasing step be carried out by pushing up an inner circumferential edge of the substrate, which has an opening at its center, from the mold side, using a push-up mechanism. In this case, the mold can be easily released without creating creases.

### —Push-up Mechanism—

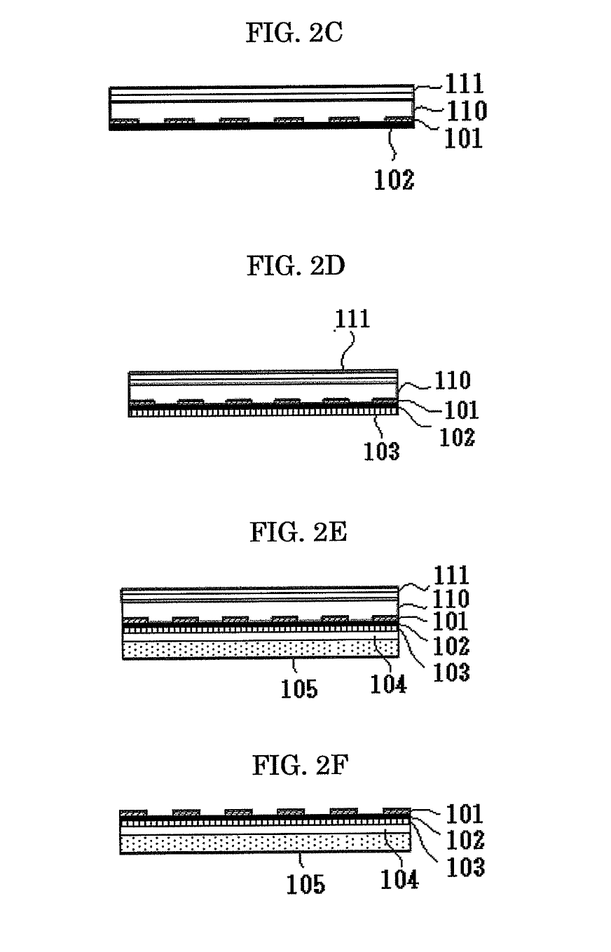

The push-up mechanism is not particularly limited and can be suitably selected according to the purpose, as long as it has a function of releasing the mold from the magnetic layer by pushing up the inner circumferential edge of the substrate (magnetic disk substrate), which has the opening at its center, from the mold side. For instance, as shown in FIG. 3A, a push-up mechanism 20 is preferably a mechanism including: a push-up pin 21 which comes into contact with an inner circumferential edge 15A of a substrate (magnetic disk substrate) 15, which has an opening, so as to push up the substrate 15; a spring 22; and a pressurizing pin 23 which pushes up the push-up pin 21, wherein the push-up pin 21 is biased toward the pressurizing pin 23 by the spring 22 in such a manner as to be able to rise. As shown in FIG. 3B, once the pressurizing pin 23 is manually or automatically pressurized, the push-up pin 21 biased toward the pressurizing pin 23 by the spring 22 is pushed up and thusly rises, then the push-up pin 21 comes into contact with the inner circumferential edge 15A of the substrate (magnetic disk substrate) 15 and pushes up the substrate 15 from the side of a mold 12. Consequently, a partially unmagnetized magnetic layer (magnetic layer+non-magnetic layer) 13 is released from the mold 12.

Additionally, as a releasing method that involves pushing up a substrate, there has been proposed a method of releasing a glass substrate bonded onto a stamper (mold) with a photopolymer that solidifies (refer to Republished Patent No. WO2003/083854); however, this method is related to release at the interface between the photopolymer and the stamper and does not disclose anything about release at the interface (metal-metal interface) between the magnetic layer and the mold, as opposed to the mold releasing step in the method of the present invention for manufacturing a magnetic recording medium.

Here, an example of a method for producing a bonded structure composed of the substrate and the magnetic layer by the magnetic layer forming step, the substrate bonding step and the mold releasing step is explained with reference to the drawings.

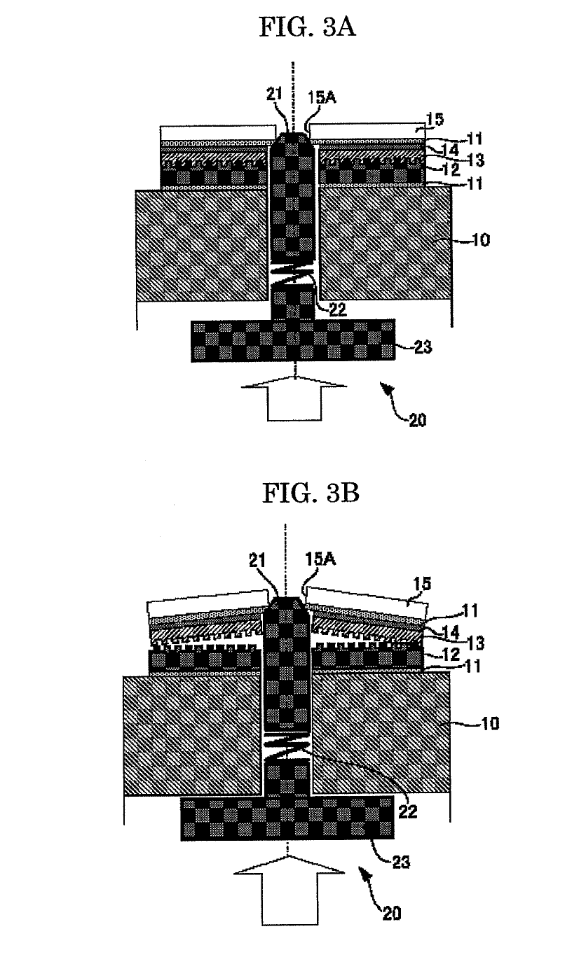

First of all, as shown in FIG. 4A, a mold 12 made of Ni is bonded and fixed onto a pedestal 10 made of SUS, using an adhesive 11, for instance. The mold 12 has on its surface a convexo-concave pattern P1 in the form of lines, in which land portions (convex portions) L and groove portions (concave portions) G are alternately aligned.

Next, after a releasing agent (not shown) is applied over the convexo-concave pattern P1 on the mold 12, a magnetic layer is formed by sputtering a magnetic material, as shown in FIG. 4B. Magnetism of a trench portion of the magnetic layer is removed from the surface of the magnetic layer on the opposite side to the mold 12 by plasma oxidation. Further, in order to facilitate writing by a perpendicular head, a soft magnetic base layer 14 (and a metal layer for maintaining strength (not shown)) is formed over a magnetic layer (magnetic layer+non-magnetic layer) 13 in which the magnetism of the trench portion has been removed (the above-mentioned base layer forming step). With this state kept, the adhesive 11 is applied over the soft magnetic base layer 14 (and the metal layer for maintaining strength (not shown)), and then a substrate (e.g. a magnetic disk substrate) 15 is bonded thereto as shown in FIG. 4C (the above-mentioned substrate bonding step).

Subsequently, as shown in FIG. 4D, when the mold 12 is released from the magnetic layer (magnetic layer+non-magnetic layer) 13 in which the magnetism of the trench portion has been removed, a bonded structure 16 is obtained which is composed of the substrate 15, the magnetic layer (magnetic layer+non-magnetic layer) 13 in which the magnetism of the trench portion has been removed, and the soft magnetic base layer 14 (and the metal layer for maintaining strength (not shown)) (the above-mentioned mold releasing step). Also, the convexo-concave pattern P1 on the mold 12 is transferred with high precision onto the surface of the magnetic layer (magnetic layer+non-magnetic layer) 13 in which the magnetism of the trench portion has been removed, thereby forming a concavo-convex pattern P2 capable of functioning as magnetic bits for patterned media.

Also, after the bonded structure composed of the substrate and the magnetic layer whose surface is provided with the concavo-convex pattern has been produced by the above-mentioned step, a magnetic layer previously formed over the mold by the magnetic layer forming step may be additionally bonded to the surface of the substrate opposite to the other surface thereof bonded to the magnetic layer, then the mold may be released from this additional magnetic layer. In this case, both surfaces of the substrate can be used, and so a magnetic disk capable of two-sided recording can be manufactured.

Further, in the case where one surface of the substrate is used as well as in the case where both surfaces thereof are used, it is desirable that a plurality of substrates be together subjected to the magnetic layer forming step, the unmagnetizing step, the base layer forming step, the substrate bonding step and the mold releasing step. In this case, a plurality of bonded structures, each of which is composed of the substrate and the magnetic layer, can be produced at the same time, and thus there is an improvement in mass productivity.

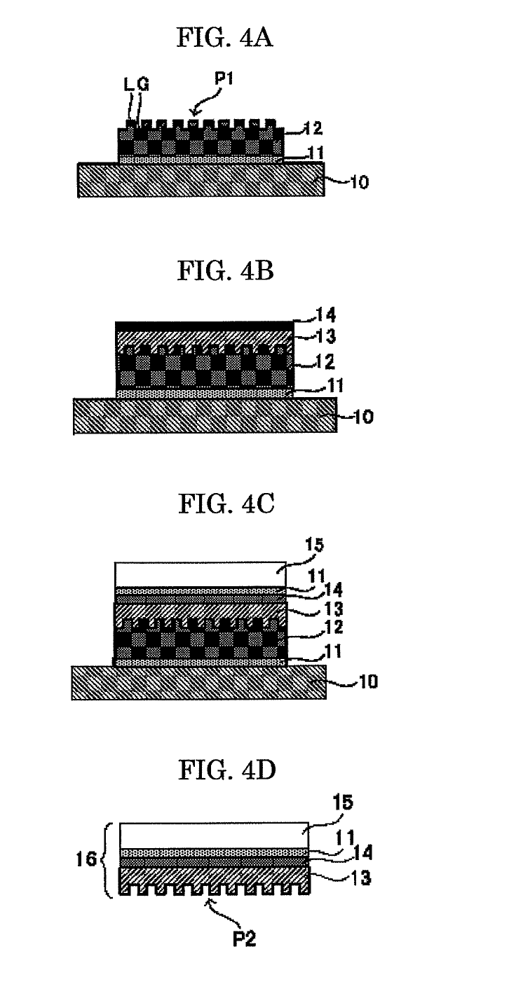

Here, a process of subjecting a plurality of substrates to those steps in the case where one surface of each substrate is used is explained below with reference to the drawings. First of all, a plurality of patterned molds 41 produced, for example, by nickel electroforming are bonded and fixed onto a pedestal 40 as shown in FIG. 5A, then the patterned molds 41 are together provided with a magnetic layer (magnetic layer+non-magnetic layer) 43 in which magnetism of a trench portion has been removed, and a base layer 44 as shown in FIG. 5B (the above-mentioned magnetic layer forming step, the above-mentioned unmagnetizing step and the above-mentioned base layer forming step). Subsequently, substrates 45 are bonded and fixed onto the base layer 44, using an adhesive 11 as shown in FIG. 5C (the above-mentioned substrate bonding step), then the patterned molds 41 are together released from the magnetic layer (magnetic layer+non-magnetic layer) 43 in which the magnetism of the trench portion has been removed, using the push-up mechanism as shown in FIG. 5D (the above-mentioned mold releasing step). Consequently, as shown in FIG. 5E, a plurality of bonded structures composed of the substrates 45 and the magnetic layer (magnetic layer+non-magnetic layer) 43 in which the magnetism of the trench portion has been removed (and the base layer 44) can be obtained at the same time, and thus throughput can be increased.

### <Additional Steps>

The additional steps are not particularly limited and can be suitably selected according to the purpose, as long as they do not impair the effects of the present invention. Suitable examples of the additional steps include a protective layer forming step.

According to the method of the present invention for manufacturing a magnetic recording medium, it is possible to transfer a convexo-concave pattern on a surface of a mold with high precision and to produce a high-definition nanosized magnetic material pattern suitable for patterned media, and it is possible to manufacture a magnetic recording medium at low cost and in a manner that is superior in productivity. Therefore, according to the method of the present invention for manufacturing a magnetic recording medium, a magnetic recording medium of the present invention to be explained below can be manufactured efficiently and at low cost.

### (Magnetic Recording Medium)

A magnetic recording medium of the present invention includes a substrate, and a magnetic material pattern over the substrate, with an adhesive layer being placed in between, and further includes additional layers suitably selected according to necessity.

### —Substrate—

The shape, structure, size, material and the like of the substrate are not particularly limited and can be suitably selected according to the purpose as described above in detail. Specific examples of the substrate include glass substrates, aluminum substrates and silicon substrates.

### —Adhesive Layer—

The adhesive layer has a function of bonding the substrate and the base layer together. The material for the adhesive layer is not particularly limited and can be suitably selected according to the purpose, and suitable examples thereof include the above-mentioned adhesives, specifically the above-mentioned epoxy resin adhesive, the above-mentioned low cure shrinkage adhesive, the above-mentioned modified silicone resin adhesive, the above-mentioned cyanoacrylate adhesive, etc.

### —Magnetic Layer—

The magnetic layer denotes a part of a magnetic layer formed in the magnetic layer forming step, that has not been unmagnetized by the unmagnetizing step. Examples of the magnetic layer include a magnetic layer incorporating a plurality of magnetic dots each having a magnetization that faces a direction substantially perpendicular to the substrate surface, a so-called perpendicular magnetization, as described above in detail.

The thickness of the magnetic layer is not particularly limited and can be suitably selected according to the purpose, and it is preferably 10 nm or less, for instance. The magnetic layer preferably has magnetic dot rows, in which the magnetic dots are regularly aligned, at constant intervals. The distance between each two adjacent magnetic dots among the magnetic dots, the width of each magnetic dot row, and the ratio of the distance to the width (distance/width) are not particularly limited and can be suitably selected according to the purpose.

Also, when the substrate is shaped like a disc, it is desirable that the magnetic dot rows be aligned at least either concentrically or spirally. Specifically, when used for a hard disk, it is desirable that they be concentrically aligned in terms of facilitation of access, whereas when used for a videodisk, it is desirable that they be spirally aligned in terms of facilitation of continuous reproduction.

Further, the magnetic dots in the adjacent magnetic dot rows are preferably aligned in the radial direction. In this case, the magnetic recording medium is very high in quality because it is large in capacity and capable of high-density and high-speed recording without needing to increase a writing current applied by a magnetic head, has superior overwriting properties and uniform properties and does not present problems, notably cross reading, cross writing, etc.

The magnetic layer is not particularly limited and can be suitably selected according to the purpose, and examples thereof include a ferromagnetic layer and a soft magnetic layer. In the present invention, it is at least necessary to form the ferromagnetic layer; and, if necessary, the soft magnetic layer may be formed between the substrate and the ferromagnetic layer; further, a non-magnetic layer (intermediate layer) may be formed between the ferromagnetic layer and the soft magnetic layer.

### —Ferromagnetic Layer—

The ferromagnetic layer functions as a recording layer in the magnetic recording medium.

The material for the ferromagnetic layer is not particularly limited and can be suitably selected from known materials according to the purpose. For instance, at least one selected from CoPt, FePt, Co/Pt multilayer film, Co/Pd multilayer film and TbFeCo is suitable. These materials may be used independently or in combination. The ferromagnetic layer is not particularly limited and can be suitably selected according to the purpose, as long as it is formed of any of the materials as a perpendicular magnetization film. Suitable examples of the ferromagnetic layer include a film having an Ll₀ regular structure in which the C axis faces a direction perpendicular to the substrate, and a film having an fcc structure or bcc structure in which the C axis faces a direction perpendicular to the substrate.

The thickness of the ferromagnetic layer is not particularly limited and can be suitably selected according to the linear recording density utilized at the time of recording, etc., as long as the thickness does not impair the effects of the present invention. For instance, a case (1) where the thickness is equal to or less than the thickness of the soft magnetic layer, a case (2) where the thickness is ⅓ times to 3 times the minimum bit length determined by the linear recording density utilized at the time of recording, and a case (3) where the thickness is equal to or less than the total thickness of the soft magnetic layer and the soft magnetic base layer are preferable. It is normally desirable that the thickness be approximately 5 nm to 100 nm, more desirably 5 nm to 50 nm, and that when magnetic recording is carried out at a linear recording density of 1,500 kBPI with 1 Tb/in² serving as a target, the thickness be 50 nm or less (approximately 20 nm).

The manner in which the ferromagnetic layer is formed is not particularly limited, and it can be formed in accordance with a known method, for example electrodeposition.

### —Soft Magnetic Layer—

The material for the soft magnetic layer is not particularly limited and can be suitably selected from known materials according to the purpose. For instance, at least one selected from NiFe, FeSiAl, FeC, FeCoB, FeCoNiB and CoZrNb is suitable. These materials may be used independently or in combination.

The thickness of the soft magnetic layer is not particularly limited and can be suitably selected according to the thickness of the ferromagnetic layer in the magnetic layer, etc., as long as the thickness does not impair the effects of the present invention. For instance, a case (1) where the thickness is greater than the thickness of the ferromagnetic layer, and a case (2) where the total of the thickness and the thickness of the soft magnetic base layer is greater than the thickness of the ferromagnetic layer are preferable.

The soft magnetic layer is capable of effectively making converge in the ferromagnetic layer a magnetic flux from a magnetic head used in magnetic recording, and thus advantageous in that a perpendicular component of the magnetic field of the magnetic head can be augmented. Additionally, it is desirable that, together with a soft magnetic base film, the soft magnetic layer be capable of forming a magnetic circuit of a recording magnetic field to be input from the magnetic head.

The manner in which the soft magnetic layer is formed is not particularly limited, and it can be formed in accordance with a known method, for example electrodeposition.

### —Intermediate Layer—

An intermediate layer formed of a non-magnetic material may be provided between the ferromagnetic layer and the soft magnetic layer. The presence of the intermediate layer formed of the non-magnetic material diminishes action of the exchange coupling force generated between the ferromagnetic layer and the soft magnetic layer, and thus control can be taken in such a manner as to obtain desired reproducing properties.

The material for the intermediate layer is not particularly limited and can be suitably selected from known materials. For instance, at least one selected from Cu, Al, Cr, Pt, W, Nb, Ru, Ta and Ti is suitable. These materials may be used independently or in combination.

The thickness of the intermediate layer is not particularly limited and can be suitably selected according to the purpose.

The manner in which the intermediate layer is formed is not particularly limited, and it can be formed in accordance with a known method, for example electrodeposition.

### —Non-Magnetic Layer—

The non-magnetic layer is formed in the above-mentioned unmagnetizing step by removing magnetism of a part of the magnetic layer from the surface of the magnetic layer opposite to the other surface thereof in contact with the mold.

The thickness of the non-magnetic layer is not particularly limited and can be suitably selected according to the purpose.

### —Soft Magnetic Base Layer—

In the magnetic recording medium, a soft magnetic base layer may be provided over the substrate.

The material for the soft magnetic base layer is not particularly limited and can be suitably selected from known materials. Suitable examples thereof include the above-mentioned materials instanced for the soft magnetic layer.

These materials may be used independently or in combination. Also, the soft magnetic base layer and the soft magnetic layer may be formed of the same or different materials.

The soft magnetic base layer preferably has a magnetization easy axis in the in-plane direction of the substrate surface. In this case, a magnetic flux from a magnetic head used in magnetic recording forms a closed magnetic circuit effectively, thereby making it possible to augment a perpendicular component of the magnetic field of the magnetic head. The soft magnetic base layer is effective also in single-domain recording with a bit size (diameter of each of the magnetic dots) of 100 nm or less.

The manner in which the soft magnetic base layer is formed is not particularly limited, and it can be formed in accordance with a known method, for example electrodeposition or electroless plating.

### —Additional Layers—

The additional layers are not particularly limited and can be suitably selected according to the purpose, and examples thereof include a protective layer.

The protective layer has a function of protecting the ferromagnetic layer and is provided above or on the surface of the ferromagnetic layer. Only one protective layer may be provided or two or more protective layers may be provided, and the protective layer may have a single-layer structure or a laminated structure.

The material for the protective layer is not particularly limited and can be suitably selected according to the purpose, and examples thereof include diamond-like carbon (DLC).

The thickness of the protective layer is not particularly limited and can be suitably selected according to the purpose.

The manner in which the protective layer is formed is not particularly limited, and it can be formed by a known method according to the purpose, for example sputtering, plasma CVD or coating.

The magnetic recording medium of the present invention can be used for a variety of types of magnetic recording using magnetic heads, notably in magnetic recording using a single magnetic pole head.

The magnetic recording medium of the present invention is capable of high-density and high-speed recording, large in capacity and high in quality. Accordingly, the magnetic recording medium can be designed and used as any type of magnetic recording medium; for example, it can be designed so as to be used in hard disk devices widely used as external storage devices for computers, consumer video recording devices, etc.; in particular, it can be suitably designed and used as a magnetic disk such as a hard disk.

### (Magnetic Recording Apparatus)

A magnetic recording apparatus of the present invention includes: a magnetic recording medium manufactured by the manufacturing method of the present invention; a magnetic recording medium rotating mechanism which rotates the magnetic recording medium; a magnetic head; an arm member incorporating the magnetic head; and a moving mechanism which moves the magnetic head by moving the arm member. The magnetic recording apparatus further includes additional layers suitably selected according to necessity.

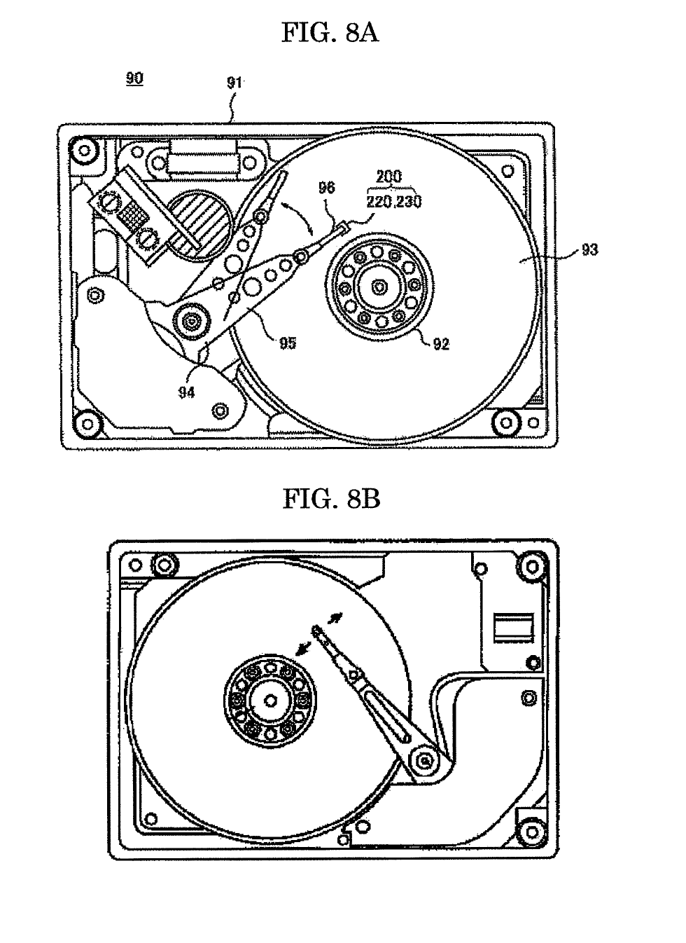

For instance, as shown in FIG. 8A, a magnetic recording apparatus 90 is mainly formed by a housing 91. Inside the housing 91, there are provided: a hub 92 driven by a spindle (not shown); a magnetic recording medium 93 fixed to the hub 92 and rotated; an actuator unit 94; an arm 95 and a suspension 96, attached to the actuator unit 94 and moved in the radial direction of the magnetic recording medium 93; and a magnetic head 200 supported by the suspension 96. The magnetic head 200 is composed of a magnetoresistance effect element 220 formed over a substrate made of ceramic, for example Al₂O₃—TiC; and an induction type recording element 230 formed thereover.

### EXAMPLES

The following explains Examples of the present invention; however, it should be noted that the present invention is not confined to these Examples in any way.

### Example 1

### —Production of Land/Groove Structure Using Mold Made of Ni—

### <Magnetic Layer Forming Step>

A Ni mold N1 was prepared that included: a structure which had the same shape as that of a glass substrate for 1-inch HDD; and a land/groove pattern (convexo-concave pattern) concentrically formed on a surface of the structure, in which land portions and groove portions were disposed at a pitch of 150 nm. The height of the land portions in the convexo-concave pattern was approximately 20 nm.

The Ni mold N1 was immersed in a 0.1% (by mass) solution of a silane coupling agent (OPTOOL DSX produced by Daikin Industries, Ltd.), which served as a releasing agent, by dipping, and then coated with the releasing agent by being subjected to air drying for 3 hr.

Next, the Ni mold N1 was set in a DC magnetron sputtering apparatus, and a CoPt film was formed over the convexo-concave pattern on the Ni mold N1 so as to have a thickness of 100 nm.

### <Unmagnetizing Step>

By exposing to oxygen plasma the surface of the CoPt layer on the opposite side to the Ni mold N1, in other words the sputtering surface of the CoPt layer, such that it was oxidized, a part (trench portion) of a magnetic layer was unmagnetized, and a non-magnetic layer was thus formed.

### <Base Layer Forming Step>

A Ru layer as a base layer was formed on the non-magnetic layer so as to have a thickness of 10 nm.

### <Substrate Bonding Step>

An adhesive (SILVER PASTE FOR DIE BONDING) was applied over the surface of the Ru layer on the opposite side to the Ni mold N1, then the glass substrate for 1-inch HDD was bonded thereto. After the adhesive had cured, part of the adhesive protruding from the glass substrate was removed using a knife.

### <Mold Releasing Step>

A blade of a knife was inserted between the glass substrate and the Ni mold so as to release the glass substrate from the Ni mold.

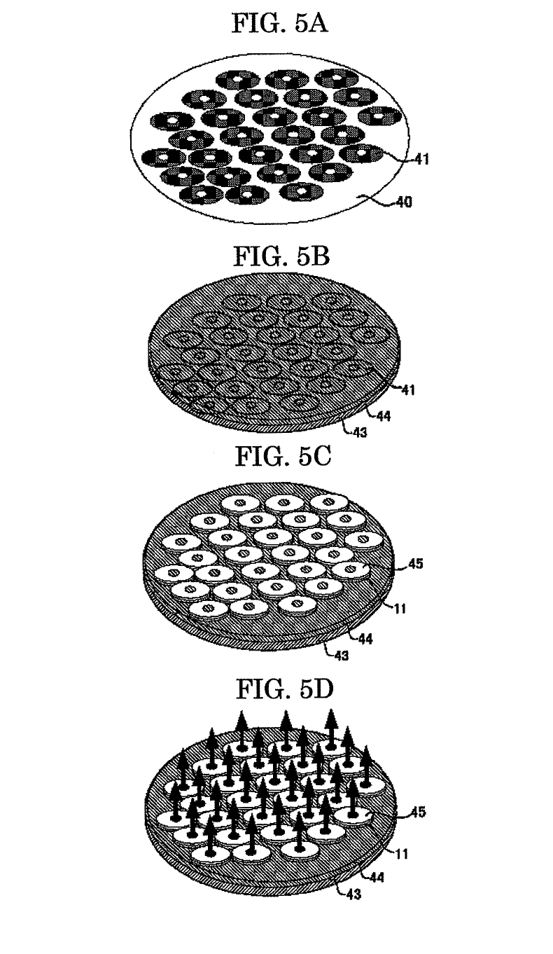

When the concavo-convex shape on the CoPt layer surface obtained was observed using an AFM, it was found that a 150 nm-pitch land/groove structure was formed as a result of faithful transfer of the concavo-convex shape on the mold (FIG. 6).

### Example 2

### —Production of Hexagonal Close-packed Dot Structure Using Thermoplastic Resin—

In the production of the land/groove structure using the mold made of Ni, a thermoplastic resin (PMMA) on which concave dots were aligned at intervals of 100 nm in the form of a hexagonal close-packed lattice was prepared instead of the Ni mold. The concavo-convex pattern on the resin was formed by thermally imprinting a mold on which convex dots were aligned at intervals of 100 nm in the form of a hexagonal close-packed lattice. The depth of the concave portions in the concavo-convex pattern was approximately 50 nm.

A magnetic layer forming step, an unmagnetizing step, a base layer forming step and a substrate bonding step were carried out similarly to those in the production of the land/groove structure using the mold made of Ni, except that the resin was used instead of the mold. In a step corresponding to the mold releasing step, the resin was dissolved by being subjected to ultrasonic cleaning in acetone.

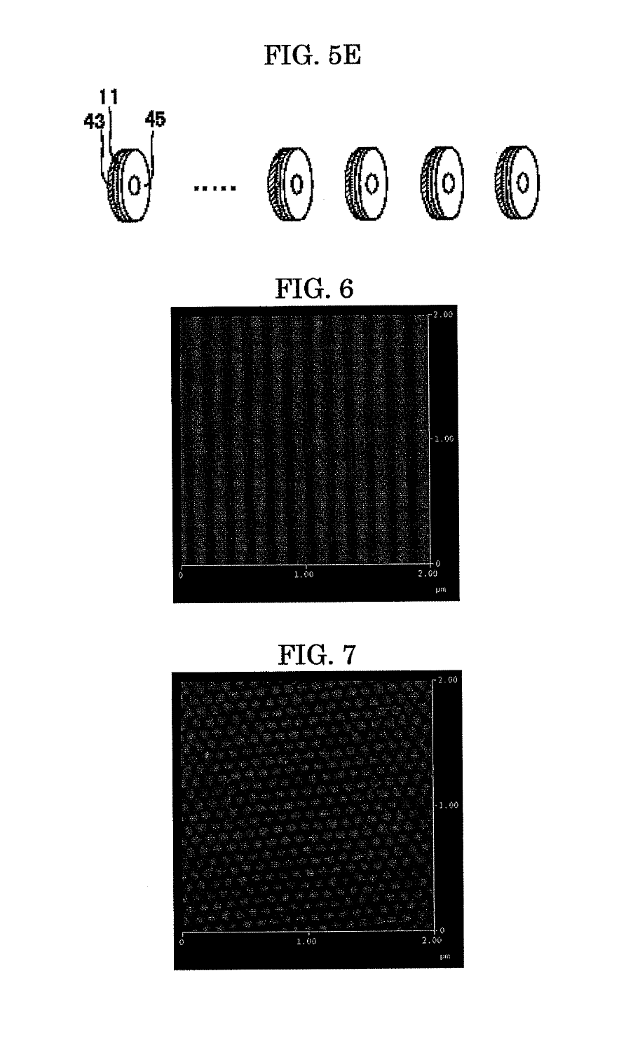

When the concavo-convex shape on the CoPt layer surface obtained was observed using an AFM, it was found that convex dot structures aligning at a pitch of 100 nm in the form of a hexagonal close-packed lattice were formed as a result of faithful transfer of the concavo-convex shape on the resin (FIG. 7).

The results of Examples 1 and 2 reveal the fact that the method of the present invention for manufacturing a magnetic recording medium dispenses with etching required in conventional methods for manufacturing magnetic recording media and is capable of manufacturing a magnetic recording medium by simply releasing a mold, thereby being capable of increasing throughput and also forming fine-sized dots repeatedly and stably.

The magnetic recording medium of the present invention can be suitably used, for example, in hard disk devices that are widely used as external storage devices for computers, consumer video recording devices, etc.

The method of the present invention for manufacturing a magnetic recording medium is superior in productivity and makes it possible to manufacture at low cost a magnetic recording medium which is large in capacity and capable of high-density recording, and the method can be particularly preferably used for manufacturing the magnetic recording medium of the present invention.

What is claimed is:

1. A method for manufacturing a magnetic recording medium which has a substrate and a magnetic layer formed on the substrate, the method comprising:
forming the magnetic layer over a convexo-concave pattern provided on a surface of a mold, and
releasing the mold from the magnetic layer formed on the substrate.

2. The method according to claim 1, further comprising unmagnetizing the magnetic layer, which involves forming a non-magnetic layer by removing magnetism of a part of the magnetic layer from a surface of the magnetic layer opposite to another surface thereof in contact with the mold.

3. The method according to claim 2, further comprising forming a base layer over the non-magnetic layer.

4. The method according to claim 3, further comprising bonding the substrate to a surface of the base layer opposite to another surface thereof in contact with the non-magnetic layer, with the use of an adhesive.

5. The method according to claim 1, wherein the convexo-concave pattern on the surface of the mold has at least either dot-shaped concave portions that are regularly aligned or land portions and groove portions that are alternately aligned.

6. The method according to claim 1, wherein the magnetic layer is formed of a perpendicular magnetization film.

7. The method according to claim 1, wherein the substrate is at least one selected from a glass substrate, an aluminum substrate and a silicon substrate.

8. The method according to claim 1, wherein the magnetic layer forming step further comprises applying a releasing agent over the convexo-concave pattern on the surface of the mold before forming the magnetic layer.

9. The method according to claim 2, wherein the unmagnetizing step further comprises flattening the surface of the magnetic layer opposite to the other surface thereof in contact with the mold.

10. The method according to claim 4, wherein the adhesive is at least one selected from an epoxy resin adhesive, a low cure shrinkage adhesive, a modified silicone resin adhesive and a cyanoacrylate adhesive.

11. The method according to claim 1, wherein the mold releasing step is carried out by pushing up an inner circumferential edge of the substrate, which has an opening at its center, from a mold side, using a push-up mechanism.

12. The method according to claim 1, wherein the mold is formed of a resin provided with a desired convexo-concave pattern, and the mold releasing step is carried out by dissolving the resin.

13. The method according to claim 4, wherein a plurality of substrates are together subjected to the magnetic layer forming step, the unmagnetizing step, the base layer forming step, the substrate bonding step and the mold releasing step.

14. A magnetic recording medium manufactured by a method for manufacturing a magnetic recording medium which has a substrate and a magnetic layer formed on the substrate, the method comprising forming the magnetic layer over a convexo-concave pattern provided on a surface of a mold and releasing the mold from the magnetic layer formed on the substrate.

15. A magnetic recording apparatus comprising:
a magnetic recording medium manufactured by a method for manufacturing a magnetic recording medium which has a substrate and a magnetic layer formed on the substrate, the method comprising forming the magnetic layer over a convexo-concave pattern provided on a surface of a mold and releasing the mold from the magnetic layer formed on the substrate,
a magnetic recording medium rotating mechanism which rotates the magnetic recording medium,
a magnetic head,
an arm member incorporating the magnetic head, and
a moving mechanism which moves the magnetic head by moving the arm member.
